(19) United States
(12) Patent Application Publication
(10) Pub. No.: US 2026/0275092 A1
(43) Pub. Date: Sep. 17, 2026

(54) ACOUSTIC BARRIER WITH ENHANCED DAMPING PERFORMANCE

(71) Applicants: Dow Global Technologies LLC, Midland, MI (US); Rohm and Haas Company, Collegeville, PA (US)

(72) Inventors: Mark P. Allen, Bruce Township, MI (US); Ian D. Robertson, Collegeville, PA (US); Hailan Guo, Warrington, PA (US); Manoj Thota, Midland, MI (US)

(21) Appl. No.: 19/168,477

(22) PCT Filed: Apr. 4, 2023
(86) PCT No.: PCT/US2023/065309

§ 371 Date: Sep. 24, 2025

(51) Int. Cl. C08L 23/0807; B60R 13/08

(52) U.S. Cl. CPC C08L 23/0815; B60R 13/0815; C08L 2205/025; C08L 2205/03; C08L 2207/02; C08L 2207/062

(57) ABSTRACT

Heterophasic thermoplastic compositions can include a polyolefin continuous phase comprising an ethylene/α-olefin interpolymer; and an acrylic discontinuous phase dispersed within the polyolefin continuous phase at a parts per hundred resin (pphr) of less than 20 pphr; wherein the composition has a tan delta of 0.11 or greater at 200 rad/s frequency. Methods may include preparing a heterophasic thermoplastic composition that include combining a polyolefin and acrylic resin to form a blend; and heating the blend to form the polyolefin continuous phase having the acrylic discontinuous phase dispersed therein.

### FIELD OF THE INVENTION

The present invention relates to heterophasic olefin acrylate hybrid materials for use in acoustic barrier and damping applications.

### BACKGROUND

Plastics and other products used in acoustic barrier materials are an important part of sound isolation in residential, automotive, and commercial environments. Acoustic barrier materials are usually made into extruded and thermoformed sheets that are trimmed and installed to improve sound attenuation of internal and/or external noise sources. Alternatively, some materials are injection molded to take the shape of the area to minimize trimming operations. Many solutions have been proposed to reduce noise and vibrations in different parts of vehicles, e.g., the use of dash mats and under flooring carpets inside the vehicle cabin is a known method to minimize noise issues.

Among plastics, acoustic barrier materials containing polyolefin resins may be thermoformable, mechanically robust, and improve sound attenuation. Non-polar polyolefin materials are often selected over other plastics (e.g. PVC or EVA) given the need for reduced emission of VOCs and associated odors. In general, increasing the density and damping (i.e., tan delta) of a barrier material increases its observed sound attenuation properties. Previous approaches to achieve this have included the addition of inorganic filler, which increases density and corresponding sound barrier properties. However, the increase in density is also accompanied by a reduction in flexibility and elongation properties, which can produce a composition too hard and brittle for fitting and operation in many intended applications.

### SUMMARY

In one aspect, the present disclosure is directed to heterophasic thermoplastic compositions that include a polyolefin continuous phase comprising an ethylene/α-olefin interpolymer; and an acrylic discontinuous phase dispersed within the polyolefin continuous phase at a parts per hundred parts resin (pphr) of less than 20 pphr; wherein the composition has a tan delta of 0.11 or greater at 200 rad/s frequency.

In another aspect, the present disclosure is directed to methods that may include preparing a heterophasic thermoplastic composition that include combining a polyolefin and acrylic resin to form a blend; and heating the blend to form the polyolefin continuous phase having the acrylic discontinuous phase dispersed therein.

### DETAILED DESCRIPTION

Embodiments relate to heterophasic thermoplastic compound compositions having a polyolefin matrix phase and a discontinuous acrylic polymer internal phase suitable for a number of acoustic barrier and damping applications. Heterophasic thermoplastic compound compositions may exhibit a density of at least 1.5 g/cc and wherein the composition has a tan delta of 0.11 or greater at 200 rad/s frequency. Methods include blending the polyolefin matrix phase with an acrylic polymer and optionally filler to generate a dispersed acrylic discontinuous phase.

Heterophasic materials disclosed herein are multiphase materials that incorporate a polyolefin continuous phase forming a matrix for a dispersed acrylic discontinuous phase that increases acoustic barrier properties, while minimizing changes in mechanical performance of the matrix phase. Particularly, by keeping the proportion of acrylic discontinuous phase in the heterophasic thermoplastic composition below a “percolation threshold” of 20 parts per hundred parts resin (pphr), the acrylic internal phase remains discontinuous and does not form an interpenetrating network. The maintenance of a discontinuous acrylic internal phase provides a material with improved sound damping performance, while minimizing the negative effects on tensile properties of the blends and copolymerized materials forming interpenetrating networks. In general, heterophasic thermoplastic compositions disclosed herein may have a density of at least 1.5 g/cc, tensile strength of 1.5 MPa or greater, and tensile elongation at break of 30% or greater. Acoustic barriers generated from the heterophasic materials may exhibit flexibility (e.g., low shore A) and suitable for assembly in a number of applications including automotive, industrial, construction, and the like.

Heterophasic thermoplastic compositions may include a polyolefin phase, which may form a continuous matrix that supports the acrylic discontinuous phase, promoting mechanical durability and tensile elongation. The combination of the polyolefin phase and the acrylic phase are defined as the polymer or “resin” portion of the heterophasic thermoplastic composition. Polyolefins may include homopolymers prepared from C2 to C10 linear, branched or cyclic α-olefin, random and block interpolymers, and random and block copolymers. Suitable polyolefins may include ethylene/α-olefin interpolymers and copolymers and propylene/α-olefin interpolymers and copolymers. α-olefins include, but are not limited to, a C3 to C20 linear, branched or cyclic α-olefins, such as propene, 1-butene, 4-methyl-1-pentene, 1-hexene, 1-octene, 1-decene, 1-dodecene, 1-tetradecene, 1-hexadecene, and 1-octadecene. The α-olefins can also contain a cyclic structure such as cyclohexane or cyclopentane, resulting in an α-olefin such as 3-cyclohexyl-1-propene (allyl cyclohexane) and vinyl cyclohexane; norbornene and related olefins; α-methylstyrene and the like. Non-limiting examples of such ethylene/α-olefin copolymers and interpolymers include substantially linear, homogeneously branched olefin interpolymers such as AFFINITY™ Polyolefin Plastomers and ENGAGE™ Polyolefin Elastomers available from The Dow Chemical Company.

Heterophasic thermoplastic compositions may include a polyolefin continuous phase having a density according to ASTM D3574-17 of 0.95 g/cc or less, 0.92 g/cc or less, or 0.90 g/cc or less, or in a range of 0.85 g/cc to 0.95 g/cc. In some cases, the polyolefin continuous phase has a melt index (2.16 kg at 190° C.) according to ASTM D1238-20 in a range of 0.8 to 10 g/10 min.

Heterophasic thermoplastic compositions may include a polyolefin continuous phase at a percent by weight (wt %) ranging from 5 wt % to 30 wt %, 10 wt % to 30 wt %, or 10 wt % to 25 wt %.

A polyolefin continuous phase may include a secondary polyolefin, such as a high density polyethylene (HDPE), to adjust stiffness and improve high temperature performance. A polyolefin continuous phase may include a fraction of HDPE having a density according to ASTM D3574-17 of 0.99 or less or 0.98 g/cc or less, or in a range of 0.93 g/cc to 0.97 g/cc.

In some cases, heterophasic thermoplastic compositions may include a high density polyethylene as a component of the polyolefin continuous phase at a percent by weight (wt %) of 10 wt % or less, 8 wt % or less, or 6 wt % or less, or in a range of 0.1 wt % to 10 wt %.

The HDPE may have a melt index (2.16 kg at 190° C.) according to ASTM D1238-20 in a range of 0.5 to 10 g/10 min.

Heterophasic thermoplastic compositions may include an acrylic internal phase forming a discontinuous distribution of acrylic particles in the polyolefin continuous phase. The acrylic discontinuous phase is added at a concentration below the percolation threshold to minimize the formation of a co-continuous phase morphology (i.e., an interpenetrating network). Without being limited by theory, generation of a co-continuous morphology may result in decreased tensile elongation and other mechanical properties.

The acrylic discontinuous phase may be prepared from one or more (meth)acrylate monomers. As used herein, “(meth)acrylate” refers to both the acrylate and methacrylate monomer forms, respectively. The acrylic internal phase may be prepared from at least one of acrylic polymer or copolymer. In some cases, the acrylic internal phase may be non-crosslinked and/or contain linear (meth)acrylate polymers. The acrylic internal phase may include one or more alkyl (meth)acrylate monomers, including derivatives of (meth)acrylate monomers having an alkyl chain ranging from 1 to 20 carbons, such as ethyl (meth)acrylate, ethyl hexyl (meth)acrylate, methyl (meth)acrylate, butyl (meth)acrylate, lauryl (meth)acrylate, poly(ethylene glycol) methacrylate, and the like.

The acrylic internal phase may include a mixture of comonomers, such as at least one of alkyl (meth)acrylate and one or more additional non-alkyl acrylate co-monomers. Suitable non-alkyl acrylate co-monomers include acrylic acid, ethylenically unsaturated aromatic monomers including styrene, alkylstyrenes (e.g., methylstyrene and ethylstyrene), acrylamide monomers (e.g., dimethyl acrylamide and diacetone acrylamide). One or more non-alkyl acrylate co-monomers may be present at a percent by weight (wt %) of the acrylic internal phase of up to 60 wt %, up to 50 wt %, or up to 40 wt %, or in a range of 0 wt % to 50 wt %.

In some cases, the acrylic internal phase may include a resin having as a percent by weight 50 wt % to 80 wt % alkyl (meth)acrylate, 0 wt % to 30 wt % styrene, and 0 wt % to 10 wt % acrylic acid.

Heterophasic thermoplastic compositions may include an acrylic internal phase having a density according to ASTM D3574-17 of 0.95 or less, 0.92 g/cc or less, or 0.90 g/cc or less, or in a range of 0.85 g/cc to 0.95 g/cc.

Acrylic internal phases may have a glass transition temperature (Tg) ranging from −60° C. to 10° C., or −40 to −10° C. as calculated by the Fox equation, and has a non-crosslinked component, wherein the non-crosslinked component has a calculated Tg less than −10° C. (or is totally non-crosslinked). The T_{g} is calculated with the Fox equation [Bulletin of the American Physical Society 1, 3 Page 123 (1956)]. The Fox equation calculates the Tg as follows:

$$\frac{1}{{T}_{g}} = \frac{{w}_{1}}{{T}_{g ( 1 )}} + \frac{{w}_{2}}{{T}_{g ( 2 )}}$$

In the Fox equation, w₁ and w₂ refer to the weight fraction of the two comonomers, based on weight of monomers charged to the reaction vessel, and T_{g(1)} and T_{g(2)} refer to the glass transition temperatures of the two corresponding homopolymers in degrees Kelvin. When three or more monomers are present, additional terms are added (wₙ/T_{g(n)}). The glass transition temperatures of homopolymers for the purposes of this disclosure are those reported in “Polymer Handbook”, edited by J. Brandrup and E. H. Immergut, Interscience Publishers, 1966, unless that publication does not report the Tg of a particular homopolymer, in which case the Tg of the homopolymer is measured by differential scanning calorimetry (DSC).

Heterophasic thermoplastic compositions may include an acrylic discontinuous phase at a part per hundred parts resin 20 pphr or less, 15 pphr or less, or 10 pphr or less, or in a range of 5 pprh to 18 pphr.

Heterophasic thermoplastic compositions may include one or more fillers including calcium carbonate, barium sulfate, silica, alumina, alumina trihydrate (ATH), wollastonite, clays (e.g., kaolin), mica, talc, fibers, particles, or beads of reinforcement materials (e.g., glass, carbon fibers, graphite, graphene, etc.), derivatives of any thereof, and the like. One or more fillers may be added at a percent by weight (wt %) of the composition ranging from 0 wt % to 85 wt %, 0 wt % to 80 wt %, or 1 wt % to 80 wt %. Filler particles sizes may vary, but may have an average particle size (d50) in a range of 1 micron to 30 micron.

Heterophasic thermoplastic compositions may also include one or more dispersants that promote dispersion, distribution, and wetting of filler additives. Suitable dispersants may include C6-C25 linear, branched, cyclic, or aromatic fatty acids, such as myristic acid, stearic acid, palmitic acid, behenic acid, oleic acid, tall oil, tall oil fatty acid, alkenylsuccinic anhydrides, monoesterified alkenylsuccinic anhydrides, and the like. Concentrations of dispersant added may be enough to promote dispersion of the filler, but below the threshold that affects thermoforming performance or results in excessive odor. In some cases, Dispersants may be added to a heteropbasic thermoplastic composition at a percent by weight (wt %) of up to 2 wt %, or up to 1 wt %, or in a range of 0.1 wt % to 2 wt %.

Heterophasic thermoplastic compositions may include a resin extender such as a processing oil or mineral oil at a percent by weight up to 10 wt %, 8 wt %, or 5 wt %.

Heterophasic thermoplastic compositions may include one or more additives that can include defoamers, color agents such as colorants, dyes or pigments, coalescent agents, film forming agents, thickeners, moisture scavengers (e.g., zeolites, molecular sieves, p-toluene sulfonylisocyanate, etc.), odor absorbers (e.g., activated carbon, zeolites, etc.) adhesion promoters, thixotropic agents, antioxidants, wetting agents such as surfactants, filler dispersion agents, thickening agents, compatibilizers, anti-settling agents anti-syneresis agents, flame retardants, and/or filler treatment agents.

Heterophasic thermoplastic compositions may have a Shore A hardness at a 10 second dwell according to ASTM D2240 of less than 100, less than 90, or less than 80.

Heterophasic thermoplastic compositions may have a tensile elongation at break according to ATSM D412 type C at 25° C. as characterized by an elongation of greater than 20%, greater than 30%, or greater than 40%.

Heterophasic thermoplastic compositions may have a density according to ASTM D792-16 of at least 1.2 g/cc, 1.5 g/cc, or 1.7 g/cc.

Heterophasic thermoplastic compositions may have a tan delta at 200 rad/s of 0.05 or greater, 0.10 or greater, 0.11 or greater, 0.14 or greater, or 0.15 or greater, or in a range of 0.05 to 0.5.

Bar torsion modes may be used to characterize shear storage modulus, loss modulus, and tan δ. Bar torsion mode may be performed on ARES-G2 (TA Instruments) using torsion fixtures on samples having a thickness of ~3 mm. During testing, a 12.75 mm wide and 40 mm long strip of the sample is punched out of the plaque and fixed by clamps. Frequency sweeps are captured in-30 to 30° C. range with 10° C. increments, 10-minute equilibration. Frequency range: 0.1-200 rad/s in a linear viscoelastic (LVE) regime.

Heterophasic thermoplastic compositions may be applied on a substrate as an acoustic barrier. These acoustic barrier parts may be produced using any known method, including injection, extrusion, extrusion and thermoforming, pultrusion, or surface application techniques, such as curtain coater, spray coater, and the like. Heterophasic thermoplastic compositions may be applied to a substrate as a melt, or formed into an article that is then applied to a substrate by gravity, adhesive, melt, or other appropriate technique.

Heterophasic thermoplastic compositions may be used as a sound damping material or acoustic barrier capable of attenuating vibrations or sound in noise, vibration, and harshness (NVH) applications, including automotive, transportation, flooring, insulation, and the like. Heterophasic thermoplastic compositions may attenuate single frequencies of vibration, all frequencies of vibrations, or one or more bands of vibration frequencies. For example, the heterophasic thermoplastic compositions polymer may attenuate vibration frequencies created by road noise, ambient noise, impacts such as footsteps, and the like.

### EXAMPLES

The following examples are provided to illustrate the embodiments of the invention, but are not intended to limit the scope thereof. Table 1 provides the materials used in the following examples. All parts and percentages are by weight unless otherwise indicated.

TABLE 1
Materials used in the examples

| COMPONENT | | DESCRIPTION | VENDOR |
|---|---|---|---|
| Polyolefin | Ethylene/Octene | ENGAGE ™ 8200 Polyolefin Elastomer, | Dow |
| Matrix | copolymer | 0.87 g/cc, MI (2.16 kg at 190° C.) | |
| | | 5 dg/min | |
| Polyolefin | HDPE | UNIVAL ™ DMDA 6400, MI (2.16 kg | Dow |
| Matrix | homopolymer | at 190° C.) 0.8 dg/min; 0.96 g/cc | |
| Acrylic | Acrylic additive | Non-crosslinked acrylic additive | Dow |
| additive with | | containing 95% Micro-White 100 and | |
| carrier | | 5% non-crosslinking styrene acrylic | |
| | | polymer with a high tan delta (−60 to | |
| | | 10 C.) | |
| Filler-1 | Micro-White 100 | calcium carbonate, 325 mesh, 2.7 g/cc | Imerys |
| Filler-2 | ExBar W325 | barium sulphate, 4.5 g/cc | Excalibar |
| Dispersant | Emery 400 fatty | dispersant containing blend of stearic | Emery |
| | acid blend | acid, palmitic acid, myristic acid and | |
| | | oleic acid. | |
| Resin | Processing oil | PON 2000 naphthenic processing oil; | Eastern Oil |
| Extender | | 0.87 g/cc | Company |
| Colorant | 66946-H1-100 | Rhapsody blue colorant | Americhem |

Sample formulations were combined using a Haake 3000 mixer according to the formulations listed in Table 2. After mixing, the resin was placed inside of a 165 mm×165 mm×3 mm steel window frame mold and nested between two polytetrafluoroethylene sheets. The plaque assembly is compressed at 2 tons for 2 minutes, followed by 24 tons and 190° C. for 2 minutes. The plaque assembly was then put into a cooling press and molded at 24 tons for 2 minutes. The resulting plaques were approximately 3 mm in thickness and 165 mm×165 mm in length and width.

TABLE 2
Sample formulations used in the examples

| Component | C1 | C2 | C3 | C4 | C5 | I1 | I2 | I3 | I4 |
|---|---|---|---|---|---|---|---|---|---|
| Ethylene/Octene copolymer (wt %) | 20 | 6.5 | 7.25 | 8 | 13.3 | 16.25 | 18.12 | 12.08 | 10.82 |
| HDPE homopolymer (wt %) | — | 9.7 | 10.9 | 12 | 6.7 | — | — | 6.05 | 5.42 |
| Acrylic additive with carrier (wt %) | — | 75 | 37.5 | — | — | 75 | 37.5 | 37.5 | 75 |
| Filler-1 (wt %) | 37.5 | 0 | 5.37 | 37.5 | 37.5 | 0 | 5.37 | 5.37 | 0 |
| Filler-2 (wt %) | 37.5 | 3.75 | 34 | 37.5 | 37.5 | 3.75 | 34 | 34 | 3.75 |
| Resin Ext. (wt %) | 4 | 4 | 4 | 4 | 4 | 4 | 4 | 4 | 4 |
| Dispersant (wt %) | 0.5 | 0.5 | 0.5 | 0.5 | 0.5 | 0.5 | 0.5 | 0.5 | 0.5 |
| Colorant (wt %) | 0.5 | 0.5 | 0.5 | 0.5 | 0.5 | 0.5 | 0.5 | 0.5 | 0.5 |
| Total (%) | 100 | 100 | 100 | 100 | 100 | 100 | 100 | 100 | 100 |
| Acrylic polymer content (wt %) | 0 | 3.75 | 1.875 | — | — | 3.75 | 1.875 | 1.87 | 3.75 |
| Acrylic polymer content (pphr) | 0 | 18.4 | 9.3 | 0 | 0 | 18.4 | 9.3 | 9.3 | 18.4 |
| Batch size | 426 | 400 | 434 | 437 | 432 | 392 | 424 | 430 | 397 |

Sample testing was performed as follows and the results are shown in Table 3 (comparative samples) and Table 4 (inventive samples).

Shore A hardness was evaluated according to ASTM D2240-21 for a 10 second dwell.

Tensile properties were tested according to ATSM D412-16 type C at room temperature on tensile bars die cut from plaques.

Density was tested per ASTM D792-16.

Modulus and tan delta were measured for bar torsion samples. Bar torsion mode was performed on ARES-G2 (TA Instruments) using torsion fixtures. A 12.75 mm wide and 40 mm long strip (3 mm thickness) of the sample was punched out of the plaque and fixed in the clamps. Frequency sweeps were captured over 0.1-200 rad/s at 23° C., with LVE regime.

For insertion loss testing, acoustic simulations were conducted on the formulations provided in Tables 3 and 4 to predict the performance. In the model, a metal substrate (CRS 0.8 mm) treated with acoustic barrier is sandwiched between a source chamber and receiving chamber. This test setup resembles “APAMAT” setup that is used by under carpet tier suppliers for validating acoustic packages that are 33″×33″ in dimensions. The source chamber is excited with both sound and vibration levels.

VA-One software is used to predict the insertion loss performance for each of the acoustic barrier compositions. Insertion loss (IL) is used as a metric for performance of the acoustic barrier and is calculated as the difference in sound pressure levels (SPL) in a hypothetical receiving chamber separated from a source chamber, where the chambers are separated by a steel substrate without and with (coating facing receiving chamber) acoustic barrier (AB) as per equation: IL=SPLₛₜₑₑₗ−SPL_{AB}

The metal substrate and acoustic barrier are modeled as isotropic materials in these acoustic simulations. The material properties of the acoustic barrier are provided in Tables 4 and 5 and the Poisson's ratio for all acoustic barrier formulations is assumed to be 0.49. The surface mass density of all acoustic barriers is kept constant, at 4.59 kg/m², in the simulations and the thickness is calculated appropriately. For example, the thickness of acoustic barrier (C1) is calculated to be 2.37 [mm] based on its density of 1.94 [g/cc].

TABLE 4
Performance Criteria and properties of comparative samples

| Property | Target | C1 | C2 | C3 | C4 | C5 |
|---|---|---|---|---|---|---|
| Acrylic level (pphr) | — | 0.0 | 18.4 | 9.2 | 0.0 | 0.0 |
| HDPE level (pphr) | — | 0 | 48.6 | 54.4 | 60 | 33.5 |
| Polyolefin matrix density (g/cc) | — | 0.870 | 0.92 | 0.92 | 0.92 | 0.90 |
| Ratio (ethylene/α-olefin copolymer/ | — | 1.00 | 0.40 | 0.40 | 0.40 | 0.67 |
| total polyolefin) | | | | | | |
| Shore A hardness | <90 | 73.6 | 92.6 | 92.6 | 89.8 | 88.8 |
| Tan Delta at 200 rad/s | >0.11 | 0.10 | 0.14 | 0.11 | 0.08 | 0.09 |
| G′ (MPa) | — | 40 | 695 | 661 | 788 | 301 |
| AB compound density (g/cc) | >1.5 | 1.94 | 1.83 | 1.98 | 1.96 | 1.97 |
| Tensile elongation at break (%) | >30 | 705 | 4.6 | 10.2 | 34 | 189 |
| Ultimate Tensile strength (psi) | — | 244 | 556 | 572 | 717 | 458 |
| Insertion Loss (dB) | — | 6.9 | 13.5 | 12.9 | 12.7 | 11.2 |

TABLE 5
Performance Criteria and properties of inventive samples

| Property | Target | I1 | I2 | I3 | I4 |
|---|---|---|---|---|---|
| Acrylic level (pphr) | — | 18.4 | 9.3 | 9.3 | 18.4 |
| HDPE level (pphr) | — | 0 | 0 | 30.3 | 27.1 |
| Polyolefin matrix | — | 0.87 | 0.87 | 0.90 | 0.898 |
| density (g/cc) | | | | | |
| Ratio | — | 1.00 | 1.00 | 0.67 | 0.67 |
| (ethylene/α-olefin | | | | | |
| interpolymer/total | | | | | |
| polyolefin) | | | | | |
| Shore A hardness | <90 | 75.2 | 74.2 | 86 | 88.8 |
| Tan Delta at | >0.11 | 0.30 | 0.23 | 0.14 | 0.18 |
| 200 rad/s | | | | | |
| G′ (Mpa) | — | 83 | 52 | 280 | 326 |
| AB compound | >1.5 | 1.79 | 1.95 | 1.97 | 1.82 |
| density (g/cc) | | | | | |
| Tensile elongation | >30 | 120 | 534 | 80 | 31.6 |
| at break (%) | | | | | |
| Ultimate Tensile | — | 232 | 172 | 413 | 430 |
| strength (psi) | | | | | |
| Insertion Loss (dB) | — | 11.4 | 9.3 | 11.9 | 12.9 |

In the examples, C1, C4, and C5 do not contain acrylic additive and exhibit tan delta values below target threshold of 0.11. C2 and C3 exhibit hardness values higher than the acceptable maximum and elongation at break values below the acceptable threshold, which is attributed to high matrix density (>40 wt % of HDPE).

In contrast, I1 meets requirements and has a tan delta >200% higher than the formulation without acrylic. Similarly, 12 meets performance requirements and exhibits a tan delta of 130% higher than the formulation without acrylic. 13 meets performance requirements and the composition has medium matrix density (0.90 g/cc) and mid-level of acrylics. 14 passes requirements and has a tan delta is 100% higher than the equivalent formulation without acrylic.

With respect to insertion loss, testing shows that addition of acrylic helps improve the acoustic performance of acoustic barrier. For example, C1 (0% Acrylic, 0% HDPE) against I1 (3.75% Acrylic, 0% HDPE) and 12 (1.875% Acrylic, 0% HDPE), illustrates that performance improved by 4.5 dB and 2.4 dB respectively. Further, including acrylic resin in polyolefin elastomer/HDPE mixtures, as in the predicted insertion loss performance of C5 (0% Acrylic and 13.3% HDPE) against 13 (1.87% Acrylic, 12.08% HDPE) and 14 (3.75% Acrylic, 10.825% HDPE), illustrates a performance improvement by 0.7 dB and 1.7 dB.

1. A heterophasic thermoplastic composition, comprising:
a polyolefin continuous phase comprising an ethylene/α-olefin interpolymer; and
an acrylic discontinuous phase dispersed within the polyolefin continuous phase at a parts per hundred parts resin (pphr) of less than 20 pphr; wherein the composition has a tan delta of 0.11 or greater at 200 rad/s frequency.

2. The composition of claim 1, wherein the composition comprises the acrylic discontinuous phase at a parts per hundred parts resin (pphr) ranging from 0.5 pphr to 20 pphr.

3. The composition of claim 1, wherein the acrylic discontinuous phase is a copolymer of butyl acrylate, styrene, and methacrylic acid.

4. The composition of claim 1, wherein the acrylic discontinuous phase has a Tg according to the Fox equation ranging from −60° C. to 10° C.

5. The composition of claim 1, further comprising an HDPE homopolymer having a density according to ASTM D3574-17 in range of 0.94 g/cc to 0.99 g/cc and at a parts per hundred parts resin (pphr) ranging from 0.1 pphr to 35 pphr

6. The composition of claim 1, wherein the polyolefin continuous phase has a density according to ASTM D3574-17 of 0.92 g/cc or less.

7. The composition of claim 1, wherein the composition has a density according to ASTM D3574-17 of at least 1.5 g/cc.

8. The composition of claim 1, wherein the acrylic discontinuous phase comprises a non-crosslinked acrylic polymer.

9. An article prepared from the composition of claim 1.

10. A method of preparing the composition of claim 1, comprising:
combining a polyolefin and acrylic resin to form a blend; and
heating the blend to form the polyolefin continuous phase having the acrylic discontinuous phase dispersed therein.
